(19) United States
(12) Patent Application Publication
(10) Pub. No.: US 2002/0156854 A1
(43) Pub. Date: Oct. 24, 2002

(54) Electronic mail management method and management system

(76) Inventor: Taisei Matsumoto, Kawasaki (JP)

Correspondence Address: MATTINGLY, STANGER & MALUR, Suite 370, 1800 Diagonal Road, Alexandria, VA, 22301, US

(21) Appl. No.: 09/940,431

(22) Filed: Aug. 29, 2001

(30) Foreign Application Priority Data
Apr. 24, 2001 (JP) 2001-126367

(51) Int. Cl. G06F 15/16

(52) U.S. Cl. 709/206

(57) ABSTRACT

There is provided an unopened electronic mail management method that can be implemented only using the function on the receiving side without depending on the specifications of a mail server on the sending side. When unopened electronic mail is managed according to a combination of mail addresses of a recipient and a sender and the unopened electronic mail that satisfies preset conditions (sending source and the time elapsed) exists, the unopened electronic mail is managed in accordance with a two-step notification method of posting to the mail recipient by a previously specified means, such as a telephone and a facsimile system, and posting to a mail sending source if the mail is kept unopened for all that.

### BACKGROUND OF THE INVENTION

1. Field of the Invention

The present invention relates to an electronic mail management method and a management system, and, more particularly, to a method and a system for managing received electronic mail so that it cannot be kept being unopened and left alone for many hours.

2. Description of the Related Arts

As a management method of unopened electronic mail, in JP-A No. 2000-270006, JP-A No. H10-136010, and JP-A No. H7-183912, a method in which the sender side specifies the unopened period of electronic mail and the period is posted to the sender when the period elapses is described. It is described in JP-A No. H11-338797, that the sender side specifies an emergency type of electronic mail, specifies time in accordance with the rank of the emergency type, specifies a transfer destination in accordance with the rank of a recipient and the emergency type, and transfers the mail to a predetermined transfer destination when the mail is unopened for the predetermined time. It is described in JP-A No. H11-154975 that only the electronic mail sent from a specified address is to be checked and the receiving is reported on the emergency screen when the mail is unopened for the predetermined time. It is described in JP-A No. H10-290256 that the number of unopened mail items is output using a voice and a summary sentence of the unopened mail is output using the voice. Further, it is described in JP-A No. H10-215318that the number of mail items that arrived newly and the number of unopened mail items are displayed on a pager.

As the communication environment, such as the Internet, is developed and the increase of a commercial transaction that makes use of electronic mail is anticipated, a mechanism is required to prevent the delay of the commercial transaction caused by delayed processing of the electronic mail. The conventional unopened electronic mail management methods have problems such that the setting of emergency type or the like is required when the electronic mail is sent and the receiving side should be of the same mail system that can identify the emergency type; there is a possibility of failing to receive unopened notification since a stepwise setting to one mail item can not be made; and a case can not be dealt with in which the recipient leaves his/her seat due to a business trip or meetings since a notification destination and notification means cannot be flexibly changed.

Basically, most management methods are to improve the convenience of a recipient, and so a feeling of security cannot be given to the sender side by the visualization of setting information. Since management by a third party is not presupposed, there is no concept of a penalty, and, as a result, the management consciousness of a user is not improved. Further, since the actual conditions of mail management of the recipient cannot be guaranteed to the sender side, the effectiveness of a commercial transaction between different companies will not be attained satisfactorily.

The transaction via the Internet and electronic mail is a transaction of a non-interview type. In some cases, a customer must be selected under conditions where there is no sufficient information about the customer company. In such a case, if there is objective information about the business management capacity of an unknown customer candidate company, the information is convenient for the selection of the customer.

### SUMMARY OF THE INVENTION

An object of the present invention, in view of the problems of such conventional art, is to provide a management method of unopened electronic mail that can be implemented only by the function of the receiving side without depending on the specifications of a mail server at the sending side, and also provide added values of authenticity and visualization of the information about the mail management to the sending source. A further object of the present invention is to present a method of providing objective information about the business management capacity of a company.

To attain the objects described above, the present invention sets multiple conditions (sending source and the time elapsed) under which unopened notification is made and posts the presence of an unopened electronic mail item to a notification destination set every time the conditions are satisfied. As a preferred embodiment, the unopened electronic mail is managed according to a combination of mail addresses between a recipient and a sender, and when there is the unopened electronic mail that satisfies the preset conditions (sending source and the time elapsed), a two-step notification method is adopted where the presence of the unopened mail is posted to the mail recipient by a previously specified means, such as a telephone and a facsimile system, and then it is posted to the mail sending source if the mail is kept unopened for all. If a service user (electronic mail recipient) adds or changes a condition under which unopened notification is made to the mail sending source, the change is validated under the condition of the approval of the relevant mail sending source. Further, when unopened notification is made to the electronic mail sending source, the results is retained on the mail management system side as a penalty result of the recipient at the mail management system side and the mail unopened result information of the user is offered to a third party including the mail sending source.

An electronic mail management method and a management system according to the present invention have the following features.

According to an aspect of the present invention, the electronic mail management method sets multiple combinations of an unopened time limit and a notification destination in an electronic mail management system, and the electronic mail management system posts the presence of unopened electronic mail to a set notification destination by a preset communication means in combination with the unopened time limit every time the unopened time limit is elapsed at which received electronic mail is kept unopened

According to this electronic mail management method, since stepwise unopened notification can be set to one electronic mail item or the notification destination and the notification means of the unopened notification can flexibly be set, the possibility of failing to receive the unopened notification can be reduced.

According to another aspect of the present invention, the electronic mail management method includes the step of posting the presence of unopened electronic mail to a recipient of the unopened electronic mail by a preset means when the unopened electronic mail exists exceeding a preset first unopened time limit and the step of posting the presence of the unopened electronic mail to a sender of the electronic mail by a preset means when the unopened electronic mail exists exceeding a second unopened time limit that is longer than the first unopened time limit.

Stepwise notification is enabled by setting multiple unopened time limits and notification destinations. For example, such a notification method that first posts the presence of the unopened electronic mail to the recipient by a facsimile system and subsequently, posts it to a cellular phone of the recipient, then posts it to a sending source when an unopened state still more continues. When the presence of the unopened electronic mail is posted to the recipient in another mail address of the recipient, it is convenient that subsequent processing can quickly be performed by transferring the original mail.

According to another aspect of the present invention, the electronic mail management method sets the first and second unopened time limits and/or notification destinations in accordance with a combination of mail addresses of a recipient and a sender.

Besides, another aspect that does not set the unopened time limit in accordance with the combination of mail addresses is also enabled. In that case, the unopened time limit ought to be set for every service user (electronic mail recipient). Similarly, another aspect that does not set the notification destination in accordance with the combination of mail addresses is also enabled. In that case, the notification destination to the service user (electronic mail recipient) can be set for every user and the notification to a sender ought to be performed using a mail reply.

According to another aspect of the present invention, the electronic mail management method sets the first and second unopened time limits and/or notification destinations in accordance with a keyword contained in a title of electronic mail.

According to this electronic mail management method, a management condition of unopened electronic mail can be changed to the same sending source according to the mail title and finer management is enabled. Further, the mail that contains a specific keyword in the title can become the object of unopened management regardless of the sending source.

According to another aspect of the present invention, the electronic mail management method sets information about a time zone where the notification can be performed to the recipient or sender of electronic mail, or the time zone where an unopened state is not to be calculated.

According to this electronic mail management method, confusion caused by arrival of a telephone and facsimile of the unopened notification at night or on holidays can be prevented from occurring.

According to another aspect of the invention, the electronic mail management method makes the contents of notification differ according to whether the notification destination of unopened information is the recipient or sender.

When the notification destination is the recipient, a message urging mail opening is posted. When the notification destination is the sender, a message reporting that the sent mail is still yet unopened is posted.

According to another aspect of the present invention, the electronic mail management method uses a mail address of a notification source when unopened notification is performed to another mail address of the recipient as the mail address of the original electronic mail sending source and uses the mail address of the notification address when the unopened notification is performed to the electronic mail sending source as a unique mail address on the electronic mail management system.

By using the mail address of the notification source when the unopened notification is performed to another mail address of the recipient as the mail address of the original electronic mail sending source, the recipient can make a reply to the sending source using the mail address. Further, by using the mail address of the notification source when the unopened notification is made to the electronic mail sending source as the unique mail address on the electronic management system, the electronic mail sending source can be guaranteed of an actual unopened state of the electronic mail as a third party.

According to another aspect of the present invention, the electronic management method charges to the user in accordance with the results to which the unopened notification is made.

According to another aspect of the present invention, the electronic mail management method charges a fee to the user in accordance with communication charges when the unopened notification is made using a notification method in which the communication charges are applied.

According to another aspect of the present invention, the electronic mail management method is provided with the steps of setting a combination of a sender mail address, a recipient address, and an unopened time limit in an unopened notification condition master and posting to the sender of electronic mail by a preset means that the electronic mail sent is unopened when the electronic mail sent from the sender mail address set in the unopened notification condition master to the recipient address is unopened exceeding the unopened time limit, and an electronic mail sending source can refer to the information of the unopened time limit that is set to be posted to the sending source by specifying the sending source mail address set in the unopened notification condition master.

According to this electronic mail management method, since the electronic mail sending source can know the mail management condition of the recipient that is an electronic mail sending destination, the management and business follow-up of the mail the electronic sending source sent are facilitated.

According to another aspect of the present invention, the electronic mail management method validates the contents of modifications under the condition of approval by the corresponding sending source when a record set in the unopened notification condition master is added, modified or deleted,

According to another aspect of the present invention of the electronic mail management method, the effect is automatically posted to the corresponding sending source when the record set in the unopened notification condition master is added, modified or deleted.

By distributing notification for quickly performing the approval using a push type, the convenience of the sending source is improved and time needed for the user who changes the management condition of unopened mail to post the effect to the sending source can be saved.

According to another aspect of the present invention, the electronic mail management method posts, to the sending source, URL (uniform resource locators) on the Internet in which the information is announced and a password for enabling the reference and approval of the information when the record set in the unopened notification condition master is added, modified or deleted.

The sending source is not limited to the user of the electronic management service, and may also not know a home page that provides the service and its own password. In that case, by distributing the notification for quickly performing the approval using a push type, the convenience of the sending source is improved and the time needed for the user who changes the management condition of unopened mail to post the effect to the sending source can be saved. The home page may also to be a page unique to the sending source and can also input a mail address as the ID of the sending source as a common page.

According to another aspect of the present invention, the electronic mail management method charges to the user in accordance with the number of setting items to the unopened notification condition master.

According to another aspect of the present invention, the electronic mail management method holds the number of received mail items that is an unopened notification management object for each recipient and the number of received mail items for which the unopened notification is made to the mail sending source among the mail items and provides the mail management information of the recipient created based on the information.

Financial conditions of a company and product force can externally be verified, but an actual state of internal business management capacity is mostly vague. According to this system, the business management capacity of the company can be estimated based on the electronic mail management capacity.

According to another aspect of the present invention, the electronic mail management system that manages unopened electronic mail has an electronic mail sending and receiving unit, an unopened notification condition master, and a notification instruction unit, and the unopened notification condition master sets a plurality of unopened time limits, unopened information notification destinations, and notification methods in accordance with a combination of the mail address of the electronic mail recipient and the mail address of the electronic mail sending source, and the notification instruction unit posts the unopened information using the notification method set in the notification destination that is set in the unopened notification condition master.

According to another aspect of the present invention, the electronic mail management system sets a first unopened time limit at which the notification destination is the recipient and a second unopened time limit that is longer than the first unopened time limit at which the notification destination is the sender in the unopened notification condition master.

According to another aspect of the present invention, the electronic mail management system enables the setting of a time zone in which the notification of unopened information is made or not made, or an unopened state is to be calculated or not to be calculated in the unopened notification condition master.

According to another aspect of the present invention, the electronic mail management system enables the setting of a keyword contained in the title of received mail and the setting of the unopened time limit, notification destination and notification method combined with the keyword in the unopened notification condition master.

According to another aspect of the present invention, the electronic mail management system above described may be enabled by a program on a computer.

### BRIEF DESCRIPTION OF THE DRAWINGS

Preferred embodiments of the present invention will be described in detail based on the followings, wherein:

FIG. 1 is a conceptual diagram of a general configuration, functions, and the connected state of an electronic mail management system according to the present invention;

FIG. 2 is a drawing showing a detailed configuration example of the electronic mail management system according to the present invention;

FIG. 3 is a drawing showing an example of an unopened notification condition master;

FIG. 4 is a drawing showing an example of a calendar master;

FIG. 5 is a drawing for describing the state in which an unopened notification time varies with the calendar setting;

FIG. 6 is an explanatory diagram of a per mail management master;

FIG. 7 is a flowchart showing a procedure of master update processing a per mail management master update unit in the case of calendar handling example 1;

FIG. 8 is a part of the procedure of master update processing the per mail management master update unit in the case of calendar handling example 2;

FIG. 9 is a drawing showing an example of a screen on which a notification condition set in the unopened notification condition master is newly set or updated; and

FIG. 10 is a drawing showing an example of an unopened notification condition approval screen.

### DESCRIPTION OF PREFERRED EMBODIMENTS

The embodiments of the present invention are described with reference to the drawings.

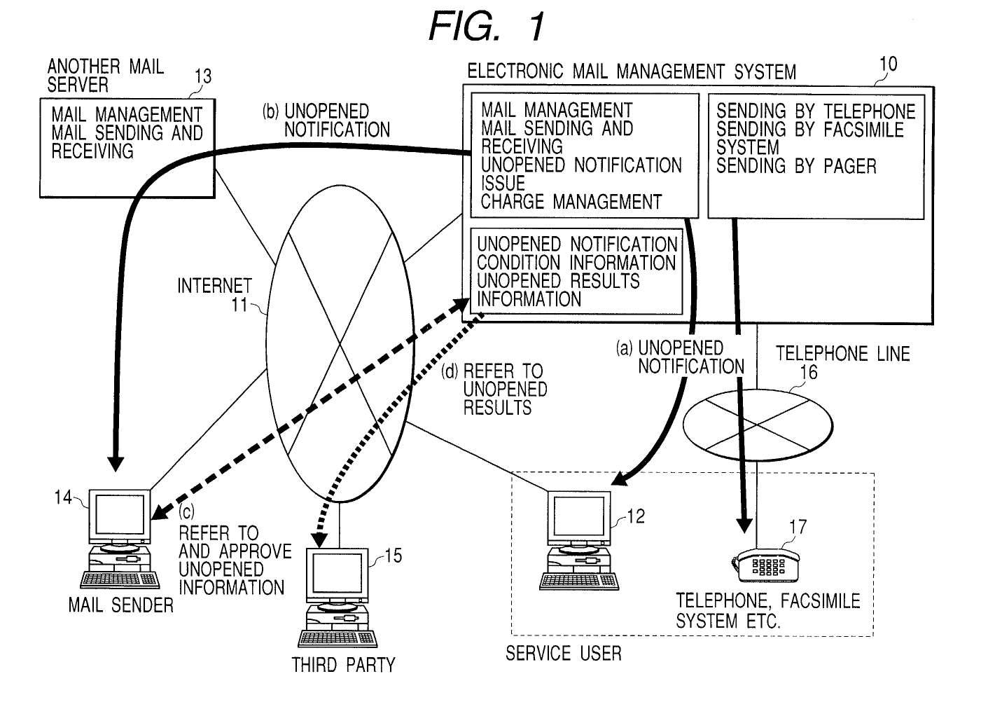

FIG. 1 is a conceptual diagram showing a schematic configuration, functions, and the connected state of an electronic mail management system according to the present invention. The electronic mail management system 10 of the present invention has an unopened notification condition information function and an unopened notification issue function of electronic mail in addition to a regular mail server function, and is connected to a terminal 12 of the user of the electronic mail management system 10, an other mail server 13, a terminal 14 of a mail sender, and a terminal 15 of a third party via the Internet 11. The electronic mail the mail sender sends to a mail address of the user of the electronic mail management system 10 is stored in a mail box of the electronic mail management system 10 from the mail server 13 of the mail sender via the Internet 11. When a service user (recipient) of this system accesses the mail box, the electronic mail is downloaded to the terminal 12 of the recipient and opened. Besides, when the mail sender is also the user of the electronic management system 10, the mail sent from the terminal 14 of the mail sender is directly stored in the mail box of the electronic mail management system 10.

When the state in which the mail that arrives at the mail box of the electronic mail management system 10 is kept unopened at the predetermined time continues and a condition set as an unopened notification condition described later is satisfied, an unopened notification issue function operates. The unopened notification issue function posts the presence of unopened electronic mail to a recipient or a sender source of the electronic mail by electronic mail or by a communication means 17, such as a cellular phone, a pager, and a facsimile system, via a telephone line 16.

In the first place, a processing outline of unopened notification by the electronic mail management system 10 of the present invention is described. When unopened mail that satisfies predetermined conditions (a sending source mail address, a received mail address, and the time elapsed) as unopened notification conditions exists in the mail box, the electronic mail management system 10 posts the presence of the unopened mail to the electronic mail recipient by a predetermined means, such as a telephone and a facsimile system (arrow (a) of FIG. 1). If the electronic mail is kept unopened for all that, it is posted to the mail sending source that the mail sent is not opened (arrow (b) of FIG. 1).

Hereupon, when the unopened notification is made by telephone, the presence of the unopened mail ought to be posted using a synthetic speech. When it is posted by a facsimile system, the title, sender, receiving time, and text (apart) of electronic mail ought to be transcribed and sent. When it is posted by a pager, the presence of the unopened mail ought to be posted using a signal. Further, when it is posted by electronic mail, mail can be transferred (a summary sentence for a PDA).

As another aspect of the present invention, when the service user adds, modifies, or deletes the contents of an unopened notification condition, the addition, modification, or deletion is validated waiting for the approval of the relevant mail sending source (dashed-line arrow (c) of FIG. 1). Further, as another use mode of this system, when the unopened notification is made to the mail sending source, it is retained in the mail management system 10 as penalty results of a recipient or a company to which the recipient belongs and the unopened results information is provided to a third party including the mail sending source as one indicator (index) that measures the business management capacity (dotted-line arrow (d) of FIG. 1).

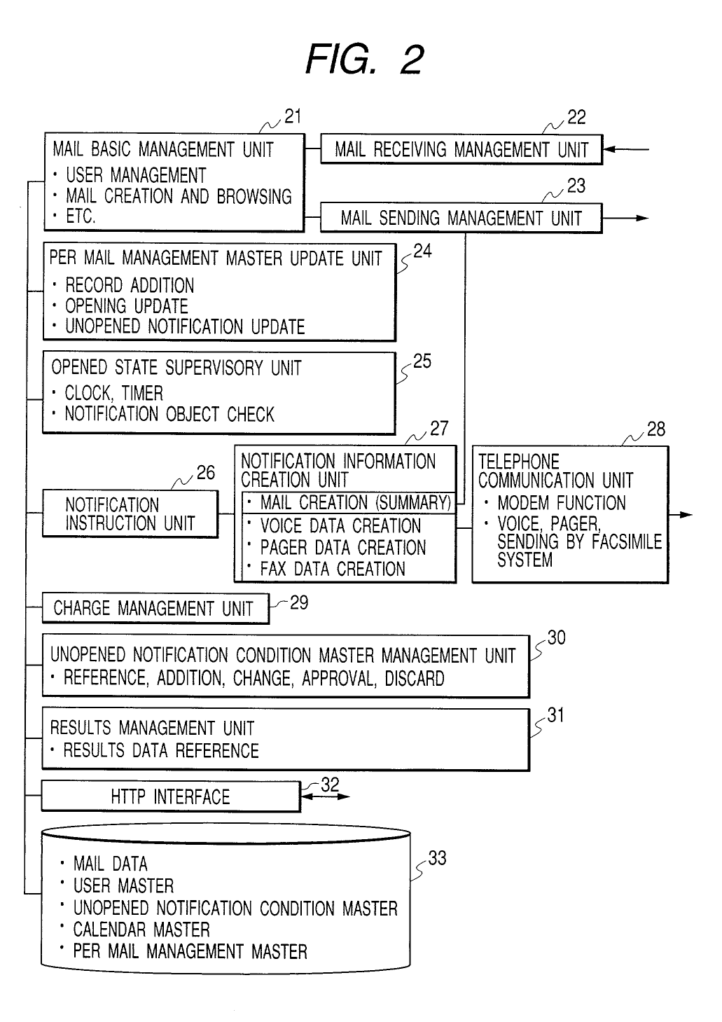

FIG. 2 is a drawing showing a detailed configuration example of the electronic mail management system 10 according to the present invention. The electronic mail management system 10 of this example has, in addition to a mail basic management system 21 that fulfills a regular mail server function, a mail receiving management unit 22, a mail sending management unit 23, a per mail management master update unit 24, an opened state monitoring unit 25 that monitors the opened state of mail, a notification instruction unit 26 that instructs the origination of unopened notification, a notification information creation unit 27 that creates notification information according to an instruction from the notification instruction unit 26, a telephone communication unit 28, a charge management unit 29 that manages a charge regarding the unopened notification, an unopened notification condition master management unit 30, a results management unit 31 that manages the results of the unopened notification, an HTTP interface 32 connected to the Internet, and a data storage unit 33.

The notification information creation unit 27 creates mail of the contents that match a purpose when unopened notification is made by electronic mail and transfers it to the mail sending management unit 23. Further, when the unopened notification is made by telephone, voice data is created. When the notification is made by a pager, pager data is created. When the notification is made by a facsimile system, facsimile data is created. The created voice data, pager data or facsimile data is transferred to the telephone communication unit 28, and the telephone communication unit 28 communicates with a predetermined telephone number, pager number, or facsimile number and makes the unopened notification. The data storage unit 33 stores an unopened notification condition master, a calendar master, and an unopened management master described later in addition to a user master that stores regular mail data and user information.

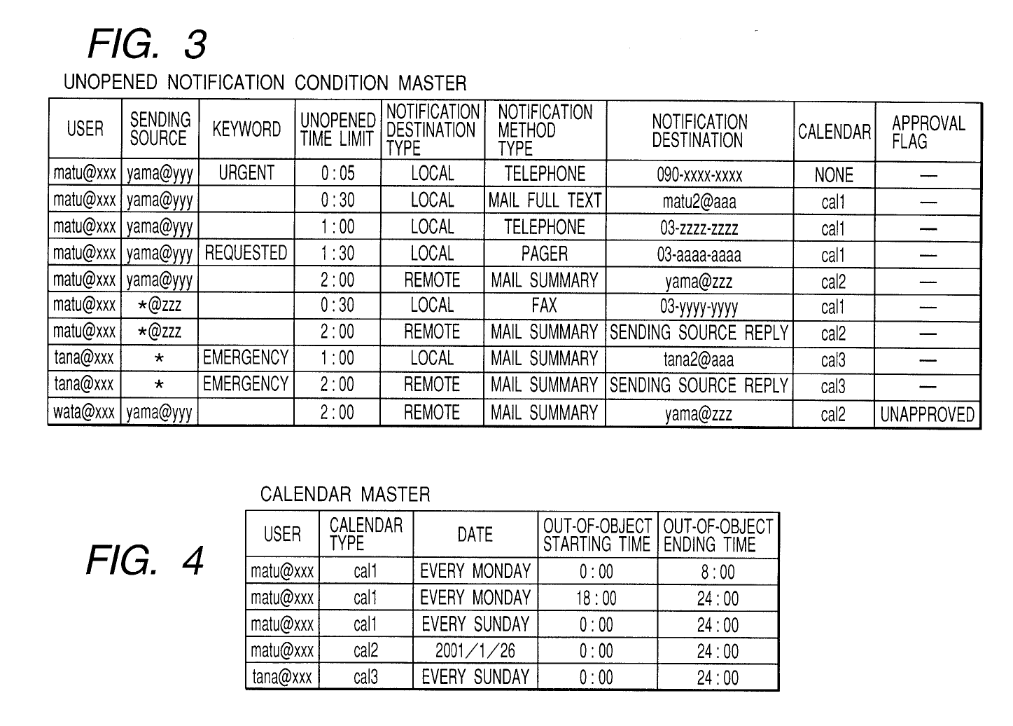

FIG. 3 is a drawing showing an example of the unopened notification condition master. A single line indicates a record. Each record has, as the field, a “User” that indicates a received mail address, a “Sending source” that indicates a sender mail address, a “keyword” that indicates a specific keyword used as a title of mail, an “Unopened time limit” that defines latency or waiting time until the unopened notification is made from mail arrival, a “Notification destination type” indicates to whom mail is posted, a “Notification method type”, that indicates how the mail is posted, a “Notification destination” that indicates a telephone number, facsimile number, and electronic mail address of the notification destination, a “Calendar” that defines a time zone where the notification is made or the time zone where an unopened state is not to be calculated, and an “Approval flag” that indicates an approved state of the record. The “User” is the user of the electronic mail management system 10 of the present invention, and each record of the unopened notification condition master sets the conditions of the unopened notification when the user is a recipient of the electronic mail.

For example, the uppermost record of FIG. 3 lays down a rule that the presence of electronic mail in a cellular phone 090-xxxx-xxxx is posted to “Local”, that is, a recipient (user) if the electronic mail is kept unopened even for a five-minute lapse from arrival of the mail when a keyword of “Urgent” is contained in the title of the electronic mail sent from a mail address of yama@yyy to a mail address of matu@xxx of the user. The next record lays down a rule that mail full text should be sent and posted to another mail address matu2@aaa of the recipient when the electronic mail sent from the mail address of yama@yyy to the mail address of matu@xxx is unopened even for a 30-minute elapse from the arrival of the mail.

In the case of the example shown, for example, when it is assumed that electronic mail that contains a keyword of “Urgent” in the title from yama@yyy to matu@xxx and a recipient cannot open the mail for some circumstances, then an unopened state continues, the unopened notification is made from the electronic mail management system 10 in the following manner. First, when five minutes elapsed from the arrival of the electronic mail, the notification indicating the unopened mail exists is made using a synthetic speech to the cellular phone 090-xxxx-xxxx of a recipient (user). Next, when 30 minutes elapse, mail full text is sent to another mail address matu2@aaa of the recipient and the presence of the unopened mail is posted. Further, when one hour elapses from the arrival of the mail, the effect indicating the unopened mail exists is posted to the fixed telephone 03-zzzz-zzzz using a synthetic speech. Nevertheless, if the mail is not opened, when two hours elapse from the arrival of the mail, a summary of the original mail is sent to another mail address yama@zzz of a sender and the fact that the mail the local side sends is not opened is posted to the sender, thereby calling the sender's attention.

Thus, when there is unopened mail, first, the presence of the unopened mail is posted to the recipient and opening is urged. Nevertheless, when the mail is not opened, the delay of a transaction caused by delayed processing of the electronic mail can be prevented by posting that the mail the local side sends to the sending source is not read yet. Besides, when the notification destination is a recipient, such a message urging the opening of mail is posted, for example, “Unopened mail is transferred.” or “Mail (title: BBBB) sent from AAAA is unopened.” On the other hand, when the notification destination is a sending source, a message reporting that the sent mail is unopened yet is posted, for example, the “Mail (title: BBBB) sent to CCCC is currently unopened at hh (hours) mm (minutes)”.

FIG. 4 is a drawing showing an example of the calendar master in which the definition of “cal1” or “cal2” described in the field “Calendar” of the unopened notification condition master of FIG. 3 is specified. The record of the calendar master shown in the example has the field of the “User”, “Calendar type”, “Date”, “Out-of-object starting time”, and “Out-of-object ending time” and defines the calendar information for every user.

The “Out-of-object starting time” and “Out-of-object ending time” of the calendar can be handled assuming that a notification-disabled time zone where unopened notification is not made is defined (calendar handling example 1). In this case, if the unopened time limit enters the notification-disabled time limit, the unopened time limit is moved down to the next notification-enabled time. For example, in the case of “cal1”, when the time when the unopened notification should be made is Sunday, the unopened notification is not made until 8:00 in the morning of the next Monday. By adding calendar information in this manner, the trouble of receiving the unopened notification by telephone regardless of time can be prevented when the mail is received at night or on a holiday that is not business hours. Further, in this method, it is interpreted as a certain type of penalty on a commercial transaction that the unopened notification is sent to the sending source. However, if the mail is received after business hours, a time is given before the penalty.

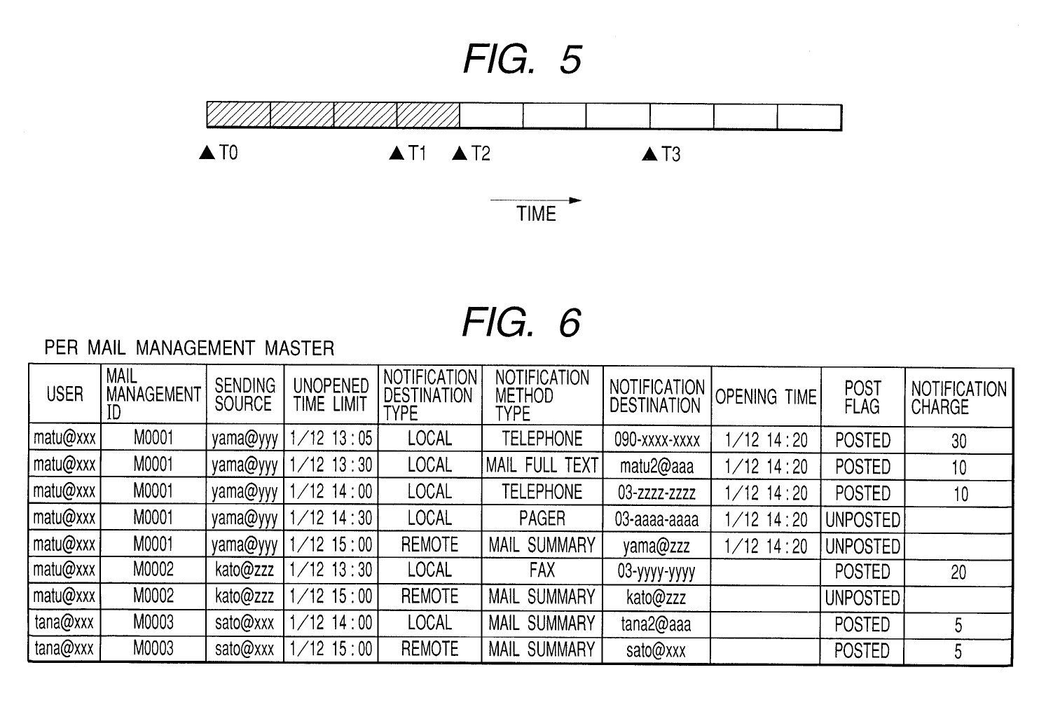

FIG. 5 is a drawing for describing how the unopened notification time is determined when the out-of-object starting time and out-of-object ending time are set using the calendar. In FIG. 5, one rectangle is one hour and the hatched portion is the out-of-object time zone. Further, the unopened time limit is three hours. Now, mail is assumed to be received at time T0. Since time T1 after three hours from the time T0 is the out-of-object time zone of unopened notification, the unopened notification time is moved down to time T2 that is the next notification-enabled time. That is, the unopened notification is made at the time T2.

As another method, the “Out-of-object starting time” and “Out-of-object ending time” set in the calendar master can be handled assuming that a time zone where an unopened state is not to be calculated is defined (calendar handling example 2). In this case, for example, in the case of “cal1”, if mail is received on Sunday, the time as an unopened state is not counted until 8:00 in the morning of the next Monday and the point of time that elapsed only by the unopened time limit from 8:00 in the morning on Monday is the notification time.

The method of determining the unopened notification time in this case is described using FIG. 5. Mail is assumed to be received at the time T0. In that case, since the time up to the time T2 is a time zone where an unopened state is not to be calculated, the time when the unopened state occurs is calculated from the time T2. As a result, the unopened notification is made at the time T3 when a three-hour unopened state elapses in the time zone where the unopened state is to be calculated.

If the out-of-object starting time and the out-of-object ending time are handled as defining the time zone where unopened notification is not made as shown in the first example, for example, if multiple items of mail are received on Sunday, the unopened notification concentrates at 8:00 in the morning on Monday. Further, if the office-going hour starts at 8:00 in the morning, no time to spare for opening mail is left and the unopened notification will be sent (penalty will occur). When the out-of-object starting time and out-of-object ending time are handled as defining a time zone where an unopened state is not to be calculated, the unopened notification can be prevented from being sent.

Besides, the unopened notification condition master and calendar master are under control of the unopened notification condition master management unit 30 shown in FIG. 2 and the user of the electronic mail management system 10 can modify the contents in accordance with the procedure described later. Further, if the standard time differs between the installation place of the electronic mail management system 10 and the place where the user exists, the time difference may be preset for every server and user is preset and the standard time ought to be converted to the standard time of the user side on the user interface. Accordingly, the user can use this electronic mail management system without a sense of incompatibility.

FIG. 6 is an explanatory drawing of a per mail management master. When mail arrives at the electronic mail management system 10, an unopened notification issue schedule regarding the arrived mail is added to the per mail management master as a record according to the unopened notification condition master shown in FIG. 3.

FIG. 6 shows an example of the record added to the per mail management master when three pieces (M0001 to M0003) of mail are received at 13:00 in the afternoon on January 12. When the mail having the mail management ID of M0001 is described as an example, this mail is sent from yama@yyy to matu@xxx and contains keywords “Urgent” and “Requested” in the title. When the unopened condition master of FIG. 3 is referred to, there are five records of which the user is matu@xxx and the sending source is yama@yyy, and of which the keyword condition is also satisfied. Accordingly, five unopened notification scheduled records are added to the per mail management master regarding the mail having the mail management ID of M0001 as shown in the drawing. Further, in consideration of the mail having the mail management ID of M0003, this mail is sent from sato@xxx to tana@xxx, and contains a keyword “Emergency” in the title. Accordingly, two unopened notification scheduled records are added referring to the unopened condition master of FIG. 3. When the notification destination of the unopened condition master is a “Sending source reply”, a sending source mail address is set in the per mail management master notification destination.

The per mail management master update unit 24 shown in FIG. 2 performs the record addition processing of the per mail management master when mail is received, the opening update processing that describes opening time when the mail is opened, and unopened notification update processing that sets the post flag to “Posted” and describes the notification charge when the unopened notification is performed. In the opening update processing, when the mail that exists in the per mail management master is opened, all opening time items of the mail having the same mail management ID are updated.

FIG. 6 shows that unopened notification is made to a user (recipient)three times at 13:05, 13:30, and 14:00 in the afternoon regarding the mail having the mail management ID of M0001, and subsequently, the user opens this mail at 14:20 in the afternoon. It also shows that the unopened notification is made to tana2@aaa at 14:00 in the afternoon regarding the mail having the mail management ID of M0003, but the mail is not opened and the unopened notification is made to the sending source at 15:00 in the afternoon.

The opened state supervisory unit 25 shown in FIG. 2 checks the per mail management master at fixed time intervals, and transfers the data of a record to the notification unit 26 if the unopened time limit is exceeded and unopened (the opening time field is space) and there is an not-posted (post flag is “Not posted”) record. The notification instruction unit 26 instructs the creation of notification information to the notification information creation unit 27 based on the transferred record data. The created information is sent as unopened notification from the mail sending management unit 23 when the communication method type is mail, and from the telephone communication unit 28 when the communication method type is a telephone, a facsimile system, and a pager. When unopened notification is performed, the per mail management master update unit 24 sets the post flag to “Posted” and updates an item of the notification charge.

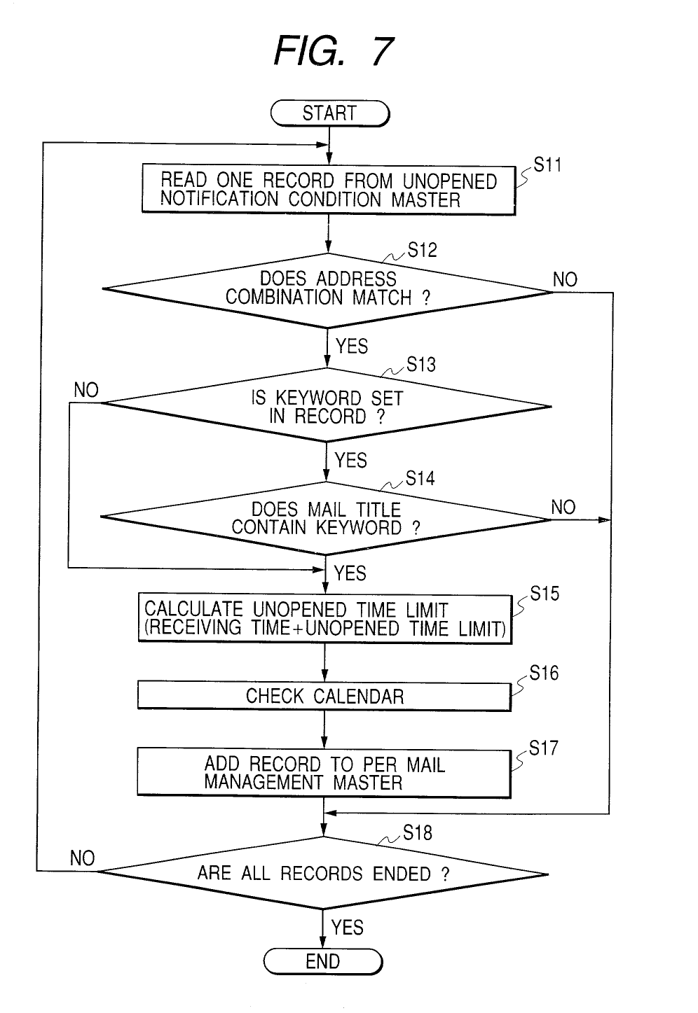

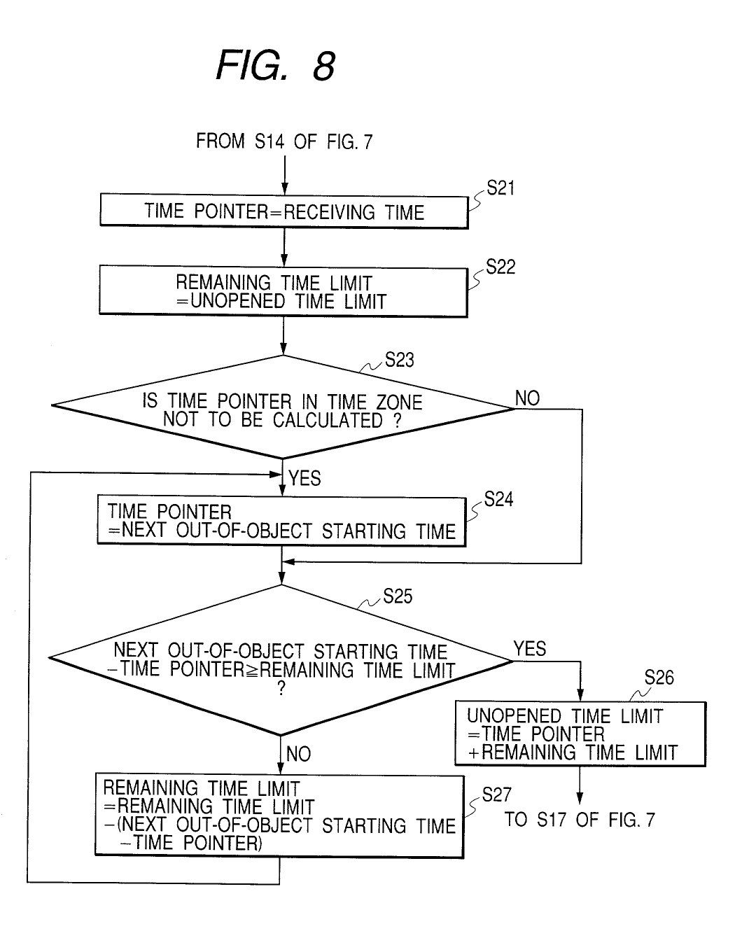

FIG. 7 is a flowchart showing a procedure of the master update processing the by-mail management master update unit 24 performs in the case of the calendar handling example 1.

When new mail is received, the per mail management master update unit 24 holds the information about the sending source mail address, received mail address, and title character string of the received mail. Subsequently, in Step 12, the first record of the unopened notification condition master is read. Then in step 12, whether a combination of the sending source mail address and received mail address of the received mail matches a combination of addresses written in the read record or not is checked. If the result is No, the processing proceeds to step 18 and records the next record. When the result is Yes, the processing proceeds to step 13 and checks whether a keyword is set in the record or not. If the keyword is not set, the processing proceeds to step 15. When the keyword is set, the processing proceeds to step 14 and determines whether the title of the received mail has the keyword. When the determination result of step 14 is YES, the processing proceeds to step 15, and when it is NO, the processing proceeds to step 18.

In step 15, unopened notification time (unopened time limit) is calculated based on the condition of a read record. Specifically, the unopened time limit is obtained by adding the unopened time limit set in the record to the mail receiving time. Next, the processing proceeds to step 16 and checks the calendar. Specifically, whether the unopened time limit calculated in step 15 enters a time zone where the unopened notification is not performed is checked referring to the calendar master based on the calendar ID of the read record. When the unopened time limit enters the time zone, the unopened time limit is moved down to the next notification-enabled time. Next, in step 17, based on the information described in the record of the read unopened notification condition master, the information obtained from the received mail, and the unopened time limit, a record is created and added to the per mail management master. The processing is repeated until the record of the unopened notification condition master is exhausted.

FIG. 8 is a flowchart showing a part of the master update process the per mail management master update unit 24 performs in the case of the calendar handling example 2. In the case of the calendar handling example 2, the processing from steps 11 to 14 shown in FIG. 7 and the processing of step 17 and later are the same processing as the calendar handling example 1. FIG. 8 shows only the processing that differs from FIG. 7 (processing that corresponds to steps 15 and 16 of FIG. 7).

After the processing of steps 11 to 14 of FIG. 7, processing proceeds to step 21 shown in FIG. 8 and sets the mail receiving time for a time pointer, then substitutes the unopened time limit for the remaining time limit in step 22. In the next step 23, whether the time pointer enters a time zone where an unopened state is not to be calculated is checked referring to the calendar master. When it enters the time zone, the processing proceeds to step 24 and sets the starting time to be calculated next as the time pointer, then proceeds to step 25. When it does not enter the time zone, the processing proceeds to step 25 as is. In step 25, whether the time when the time pointer is subtracted from the next out-of-object starting time is greater than the remaining time limit is determined. When the determination result is YES, the time when the remaining time limit is added to the time pointer is set as the unopened time limit and the processing proceeds to step 17 of FIG. 7. Further, when the determination result is NO, in step 27, the time when (next out-of-object starting time—time pointer) is subtracted from the remaining time limit is re-set as the remaining time limit. The processing returns to step 24 and is repeated.

Next, the processing at the time when the contents of the unopened notification condition master are changed is described.

The setting information, such as the unopened notification conditions or notification procedure set in the unopened notification condition master, is also made public to the sender side, and the change of the conditions ought also be validated for the first time after the approval of the sender. If structure that guarantees the conditions of both-party agreements by the service the electronic mail management system provides and prevents the service user from freely changing the conditions is provided, the mail unopened information is posted to the sender under the conditions authorized by the sender. Accordingly, the mail opened state on the recipient side is made clear. The delay of business can be prevented as the recipient by posting the presence of unopened mail to the local side. In addition to this, it can be promised to the sending side (customer) that mail management is being executed under the conditions authorized by the sender, and the quality of business management can be appealed.

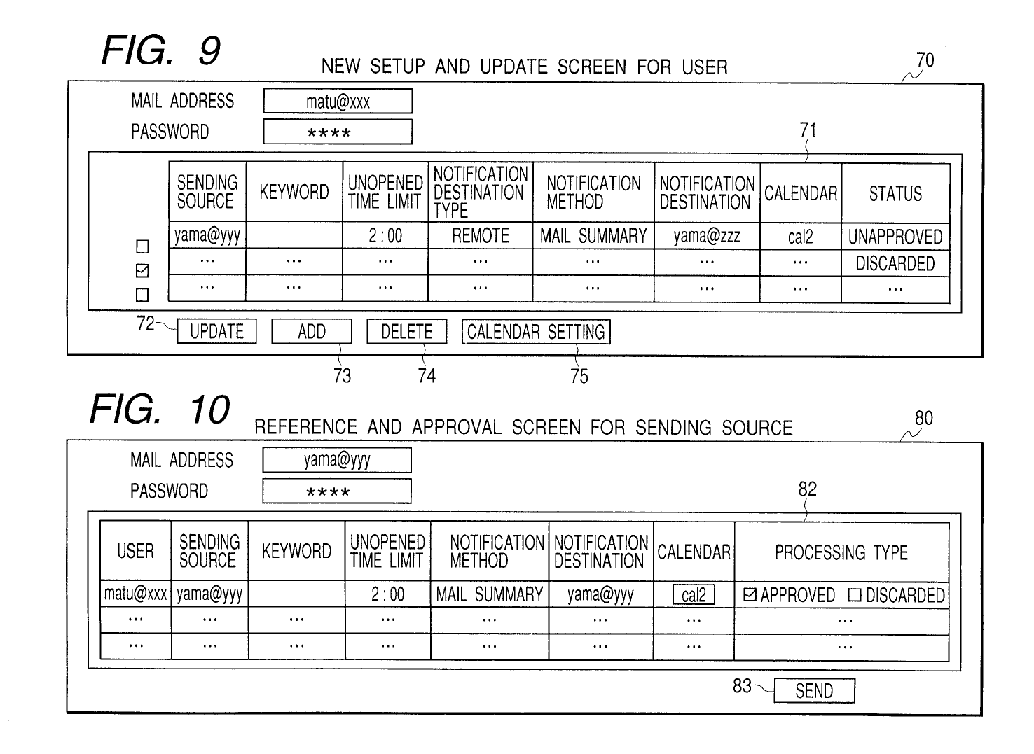

FIG. 9 is a drawing showing an example of the screen on which the user of the service of an electronic mail management system newly sets or updates the notification conditions set in the unopened notification condition master.

When a user enters his or her mail address and password on a notification condition setting screen 70, a record 71 of the unopened notification condition set for the user is listed. To correct the condition, the user rewrites a part of the data of the displayed record and presses an Update button 72. To add a new condition record, the user additionally writes one line and presses an Add button 73. Further, to delete the record, the user checks the check box of the record and presses a Delete button 74. By pressing the Update button 72, the Add button 73, or the Delete button 74 stores the updated or newly set contents are stored and enters the approval wait state is entered when the notification destination type is “Remote”. The condition before change is made valid until the sending source approves it. In FIG. 3, setting the approval flag to “Unapproved” indicates that the user updates the unopened notification condition in this manner and is waiting for the approval made by the sending source. Further, pressing a Calendar Setting button 75 sets and changes the calendar data shown in FIG. 4.

FIG. 10 is a drawing showing an example of an unopened notification condition reference and approval screen 80 for a sending source. When the sending source enters his or her mail address and password on this reference and approval screen 80, a record 82 in which the sending source having the mail address becomes the object of unopened notification is displayed. The record that is displayed is only the record in which the “sending source” matches the input mail address in the records set in the unopened notification condition master and the “notification destination type” is “Remote”. Further, clicking the contents of a calendar displays the relevant calendar, thereby enabling confirmation of the contents.

A service user (recipient) changes the contents of the record in which the characters of “Approved” and “Discarded” with the checkbox in the processing type are displayed on the reference and approval screen and waits for the approval made by a sending source. To approve the changed condition, the sending source checks the “Approved” of the processing type on this reference and approval screen and presses a Send button 83. Accordingly, the updated condition is validated. Further, if the change is not desirable, the sending user checks the “Discarded” of the processing type and presses the Send button 83. To discard the contents on the Web server, the sending source automatically creates mail in which a sentence representing the discarded contents is described to the service user that is the condition setting source and the sending source who discarded the contents additionally describes the reason, then may send the mail to the user.

Further, when the reference and approval screen is displayed, an attempt is made to also be able to input an address of a sending destination (recipient) as an additional condition for selecting a display object. Further, to refer to information as previously described, a password may be provided, but the sending source does not always use the electronic mail management service. Hereupon, as a password notification method, a method of making a notification request for the password to the electronic mail management service center by a Web server or electronic mail and returning the password to the relevant sending source mail address is considered. The password may also be a one-time password of which the period is limited. Otherwise, when the recipient who is the electronic mail management service user sets the sending source in the unopened notification condition master, a unique password may also be assigned.

Further, the relevant information may also be sent by electronic mail in the same manner as the password notification method instead of performing reference on a Web server. That is, a sending request for the unopened time limit information is made to the electronic mail management service center by the Web server and electronic mail, and the information may also be returned to the sending source mail address. At this time, the information shall be certified in person using an address of requested mail.

The unopened condition master management unit 30 performs the change and addition processing of an unopened condition by a system user and the approval and discard processing of the unopened condition reference or condition change by a mail sending source.

Next, a method for charging a fee for the use of the unopened mail management function is described. The charge method includes a method for charging a fee in accordance with the amount (the number of sending sources to be set) of a setting condition and a method of charging the fee to the user in accordance with the results to which unopened notification is made.

To charge a fee in accordance with the amount of setting condition, for example, the fee is charged to the user in accordance with the number of master setting items. Specifically, the number of condition master items in the beginning of a charge period (for example, month) is held and the number of condition master items every time it is added later is counted up (incremented). Even if the number of charge items is deleted, that within this period shall not be changed. At this time, an amount of money may also be changed in accordance with the contents of setting.

When a fee is charged to the user in accordance with the results of unopened notification, for example, an item of the post flag is provided on the per mail management master and the fee is charged for the record of which the flag is “Posted” within the charging object period. An amount of money may also be changed in accordance with the notification condition. In the case of notification by mail, the fee may also be charged in accordance with the capacity of mail.

Otherwise, the method of charging a fee to the user in accordance with communication charges can also be adopted. In this case, an item of a notification charge is provided on the per mail management master and the fee applied every notification is set, then is accumulated within a charge object period.

By charging a fee for an unopened notification service, convenience of mail users in a commercial transaction is improved and a business for a mediator who manages and guarantees mail sending and receiving as a third party as added values is established. The mediation of a service entry by the third party in the form that the entry into this service is recommended is anticipated so that a company can improve the convenience in the commercial transaction or the EC site can prevent trouble. As a service user, the service quality can be appealed to a customer by impressing the perfection of mail management. Further, the utilization of the service can be promoted by using such a state of mind that inevitably sets unopened notification due to demand from the customer or sets the unopened notification so that it can also arrive at the local side previously as insurance for preventing the unopened notification from being sent to the customer that is a sending source.

Further, since the information about the unopened notification stored in the electronic mail management system of the present invention is used as an index that judges the business management capacity of the service user (company) that is a mail recipient, business that distributes this unopened results information to a third party as the mail management fact-finding information for the recipient is also established.

Specifically, based on all unopened management object mail of the service user, the number of unopened notification items and a notification rate are calculated and efficiently used as company rating information. When this information is distributed to a third party, an address of the sending source and a notification destination are not made public. Further, when unopened notification results are used for estimating the business management capacity of a customer company, only the notification made to the sending source is targeted and the notification made to the local side is not targeted.

According to the electronic mail management system of the present invention, unopened management is also enabled in the mail operating environment between companies that use different types of mail servers, and the unopened management can also be performed between the companies having the mail server of different specifications in addition to the situation where the same mail system is used in the same company.

According to the present invention, since unopened notification is enabled regardless of the specifications on the mail sending side, the utilization between companies is enabled. Further, the time limit and notification destination of the unopened notification can individually be set, and finer management is enabled. Since an unopened processing condition is set under the approval of the mail sender, the opened state on the recipient side is made clear. Furthermore, unopened results information can be used as an index that estimates the business management capacity of the customer company.

What is claimed is:

1. An electronic mail management method by which multiple combinations of an unopened time limit and a notification destination are set in an electronic mail management system, wherein the electronic mail management system posts the presence of unopened electronic mail to a set notification destination by a preset communication means in combination with the unopened time limit every time the unopened time limit at which received electronic mail is kept unopened is elapsed.

2. An electronic mail management method, comprising the steps of:
posting the presence of unopened electronic mail to a recipient of the unopened electronic mail by a preset means when the unopened electronic mail exists exceeding a preset first unopened time limit; and
posting the presence of the unopened electronic mail to a sender of the electronic mail by a preset means when the unopened electronic mail exists exceeding a second unopened time limit that is longer than the first unopened time limit.

3. The electronic mail management method according to claim 1 or 2, wherein the first and second unopened time limits and/or notification destinations are set in accordance with a combination of mail addresses of the recipient and the sender.

4. The electronic mail management method according to claim 1, 2 or 3, wherein the first and second unopened time limits and/or notification destinations are set in accordance with a keyword contained in a title of the electronic mail.

5. The electronic mail management method according to any one of claims 1 to 4, wherein information about a time zone where the notification can be performed to the recipient or sender of electronic mail or the time zone where an unopened state is not to be calculated.

6. The electronic mail management method according to any one of claims 1 to 5, wherein the contents of notification are made to differ according to whether the notification destination of unopened information is the recipient or sender.

7. The electronic mail management method according to any one of claims 1 to 6, wherein as a mail address of a notification source when unopened notification is performed to another mail address of the recipient is used the mail address of the original electronic mail sending source and as a mail address of a notification source when unopened notification is performed to the electronic mail sending source is used a unique mail address on the electronic mail management system.

8. The electronic management method according to any one of claims 1 to 7, wherein charging is performed to the user in accordance with the results to which the unopened notification is performed.

9. The electronic mail management method according to any one of claims 1 to 7, wherein a fee is charged to the user in accordance with communication charges when the unopened notification is made using a notification method in which the communication charges are applied.

10. An electronic mail management method, comprising the steps of:
setting a combination of a sending source mail address, a receiving mail address, and an unopened time limit in an unopened notification condition master; and
posting to a sender of electronic mail by a preset means that the electronic mail sent is unopened when the electronic mail sent from the sending source mail address set in the unopened notification condition master to the receiving mail address is unopened exceeding the unopened time limit,
wherein an electronic mail sending source can refer to the information of the unopened time limit that is set to be posted to the sending source by specifying the sending source mail address set in the unopened notification condition master.

11. The electronic mail management method according to claim 10, wherein the contents of modifications are validated under approval of the corresponding sending source when a record set in the unopened notification condition master is added, modified or deleted,

12. The electronic mail management method according to claim 11, wherein the effect is automatically posted to the corresponding sending source when the record set in the unopened notification condition master is added, modified or deleted.

13. The electronic mail management method according to claim 11, wherein URL (uniform resource locators) on the Internet in which the information is announced and a password for enabling the reference and approval of the information to the sending source when the record set in the unopened notification condition master is added, modified or deleted are posted.

14. The electronic mail management method according to anyone of claims 10 to 13, wherein charging to the user is performed in accordance with the number of setting items to the unopened notification condition master.

15. The electronic mail management method according to claims 1 to 14, wherein the number of received mail items that is an unopened notification management object for each recipient and the number of received mail items for which the unopened notification is performed to the mail sending source among the mail items are held and the mail management information of the recipient created based on the information is provided.

16. The electronic mail management method according to claims 1 to 15, wherein a program is enabled on a computer.

17. An electronic mail management system that manages unopened electronic mail, comprising:
an electronic mail sending and receiving unit, an unopened notification condition master, and a notification instruction unit, wherein
the unopened notification condition master sets a plurality of unopened time limits, unopened information notification destinations, and notification methods in accordance with a combination of the mail address of the electronic mail recipient and the mail address of the electronic mail sending source, and
the notification instruction unit posts the unopened information using the notification method set in the notification destination that is set in the unopened notification condition master when unopened electronic mail exists even if the unopened time limit set in the unopened notification condition master elapses.

18. The electronic mail management system according to claim 17, wherein a first unopened time limit at which the notification destination is the recipient and a second unopened time limit that is longer than the first unopened time limit at which the notification destination is the sender are set in the unopened notification condition master.

19. The electronic mail management system according to claim 17 or 18, wherein a time zone in which the notification of unopened information is made or not made, or an unopened state is to be calculated or not to be calculated can be set in the unopened notification condition master.

20. The electronic mail management system according to claim 17, 18 or 19, wherein the setting of a keyword contained in the title of received mail and the setting of the unopened time limit, notification destination and notification method combined with the keyword can be set in the unopened notification condition master.

21. The electronic mail management system according to any one of claims 17 to 20, wherein a program is enabled on a computer.
